(19) United States
(12) Patent Application Publication
(10) Pub. No.: US 2022/0128996 A1
(43) Pub. Date: Apr. 28, 2022

(54) CONTROL APPARATUS, CONTROL METHOD, AND PROGRAM

(71) Applicant: SONY GROUP CORPORATION, TOKYO (JP)

(72) Inventor: SHINGO TSURUMI, TOKYO (JP)

(21) Appl. No.: 17/310,836

(22) PCT Filed: Feb. 19, 2020
(86) PCT No.: PCT/JP2020/006650

§ 371 Date: Aug. 26, 2021

(30) Foreign Application Priority Data
Mar. 6, 2019 (JP) 2019-040544

(51) Int. Cl. G05D 1/02; G05D 1/10; G01W 1/10; G01W 1/08; B64D 47/08; B64C 39/02

(52) U.S. Cl. CPC G05D 1/0204; G05D 1/104; G01W 1/10; G01W 1/08; G01W 2001/003; B64C 39/024; B64C 2201/108; B64C 2201/127; B64C 2201/14; B64D 47/08

(57) ABSTRACT

A control apparatus includes a reception section that receives a wind speed vector measured at any time point by at least one external anemometer, a wind-power prediction section that, on the basis of the received wind speed vector, predicts a wind power to be applied to the mobile body after elapse of a predetermined time period, and a control section that controls driving of the mobile body on the basis of the predicted wind power.

### TECHNICAL FIELD

The present disclosure relates to a control apparatus, a control method, and a program.

### BACKGROUND ART

In recent years, a study is made on how to efficiently perform a work on a region of a wide range from a position in the air by using a compact flying body such as a drone.

For example, PTL 1 mentioned below discloses a technology of distributing fertilizer or the like toward a field by using an aircraft machine body. In addition, it is common to capture an image of a wide area from a position in the air by using a drone or the like having an imaging apparatus mounted thereon.

In a case where a flying body is used to perform the work, it is important to stably keep the flying body at a predetermined position during the work, or to make the flying body fly stably along a predetermined track. Thus, there has been developed a technology of, in a case where the position of a flying body that is hovering changes due to a strong wind, for example, automatically moving the flying body back to the position where the flying body was present, before the strong wind blew, by using a GNSS (Global Navigation Satellite System) sensor or the like.

### CITATION LIST

### Patent Literature

### PTL 1

Japanese Patent Laid-Open No. 2018-127076

### SUMMARY

### Technical Problem

However, with the abovementioned technology, it is difficult to prevent the position and the posture of a flying body from temporally becoming unstable when a strong wind blows. For this reason, a technology of keeping the position and the posture of a flying body as stably as possible even in a case where a sudden strong wind blows has been demanded.

### Solution to Problem

The present disclosure provides a control apparatus including a reception section that receives a wind speed vector measured at any time point by at least one external anemometer, a wind-power prediction section that, on the basis of the received wind speed vector, predicts a wind power to be applied to a mobile body after elapse of a predetermined time period, and a control section that controls driving the mobile body on the basis of the predicted wind power.

In addition, the present disclosure provides a control method including receiving a wind speed vector measured at any time point by at least one external anemometer, predicting, by an arithmetic device, on the basis of the received wind speed vector, a wind power to be applied to a mobile body after elapse of a predetermined time period, and controlling driving of the mobile body on the basis of the predicted wind power.

Moreover, the present disclosure provides a program for causing a computer to function as a reception section that receives a wind speed vector measured at any time point by at least one external anemometer, a wind-power prediction section that, on the basis of the received wind speed vector, predicts a wind power to be applied to a mobile body after elapse of a predetermined time period, and a control section that controls driving of the mobile body on the basis of the predicted wind power.

### BRIEF DESCRIPTION OF DRAWINGS

FIG. 1 is an explanatory diagram depicting one example of a mobile body that is under control of a control apparatus according to one embodiment of the present disclosure.

FIG. 2 is a block diagram for explaining a functional configuration of the control apparatus according to the embodiment.

FIG. 3 is a schematic diagram depicting one example of a heat map indicating wind speed vectors at respective positions in a predetermined environment.

FIG. 4 is an explanatory diagram for explaining a method of predicting a wind speed vector at a first mobile body, from a wind speed vector at a second mobile body.

FIG. 5 is a flowchart for explaining an operation flow of the control apparatus according to the embodiment.

FIG. 6A is an explanatory diagram depicting an example in which plural second mobile bodies each including an anemometer are used to cause the first mobile body including an imaging apparatus to make a stable flight.

FIG. 6B is an explanatory diagram depicting an example in which plural first mobile bodies each including an anemometer and an imaging apparatus are caused to make mutually stable flights.

FIG. 7A is an explanatory diagram depicting an arrangement example of the first mobile body and the second mobile body.

FIG. 7B is an explanatory diagram depicting an arrangement example of the first mobile body and plural second mobile bodies.

FIG. 8 is an explanatory diagram for explaining an observation machine including an anemometer that measures a wind speed vector.

FIG. 9 is a block diagram depicting one example of a hardware configuration of the control apparatus according to the embodiment.

### DESCRIPTION OF EMBODIMENT

A preferred embodiment of the present disclosure will be explained in detail below with reference to the attached drawings. It is to be noted that components having substantially the same functional configuration will be denoted by the same reference signs throughout the present description and the drawings, and a redundant explanation thereof will be omitted.

It is to be noted that the explanation will be given in the following order.

1. Outline of Control Apparatus

2. Configuration of Control Apparatus

3. Operation of Control Apparatus

4. Variations

5. Hardware Configuration

### <1. Outline of Control Apparatus>

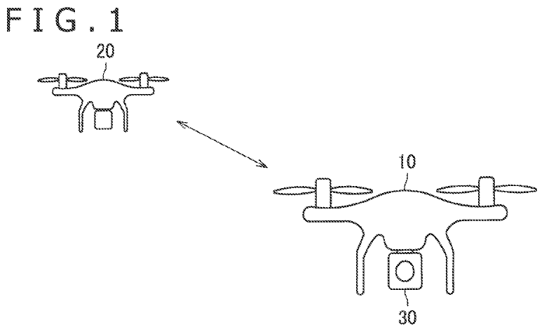

First, the outline of a control apparatus according to one embodiment of the present disclosure will be explained with reference to FIG. 1. FIG. 1 is an explanatory diagram depicting one example of a mobile body that is under control of the control apparatus according to the present embodiment.

It is to be noted that a flying body will be described as one example of the mobile body in the following description, but the mobile body that comes under the control of the control apparatus according to the present embodiment is not limited to such an example. The mobile body that comes under the control of the control apparatus control apparatus does not need to fly.

As depicted in FIG. 1, the control apparatus according to the present embodiment controls the position and the posture of a first mobile body 10 which flies. Specifically, the control apparatus according to the present embodiment controls the position and the posture of the first mobile body 10 that performs a work on a region of a wide range from a position in the air, on the basis of a wind speed vector measured by a second mobile body 20 that includes an anemometer. It is to be noted that the control apparatus according to the present embodiment may also control the position and the posture of the second mobile body 20 including the anemometer.

For example, the first mobile body 10 is a flying body such as a helicopter or a multicopter that includes an imaging apparatus 30 and that flies with a rotary blade. The first mobile body 10 can capture an image of a region of a wide range from a position in the air by using the imaging apparatus 30, for example.

However, the first mobile body 10 may include any apparatus other than the imaging apparatus 30 as long as the apparatus performs a work on a region of a wide range from a position in the air. For example, the first mobile body 10 may include a measurement apparatus that measures a topographical feature of a wide range from a position in the air, or a distributing apparatus that distributes liquid or a solid object toward a region of a wide range from a position in the air.

It is important that the position and the posture of the first mobile body 10 are stable because the first mobile body 10 performs a work on a region of a wide range from a position in the air. Specifically, it is important for the first mobile body 10 to, even in a case of receiving a sudden strong wind or the like, make a flight while keeping the position and the posture of the first mobile body 10 undisturbed as much as possible.

The second mobile body 20 includes an anemometer, for example. Similarly to the first mobile body 10, the second mobile body 20 is a flying body such as a helicopter or a multicopter that flies with a rotary blade. By using the anemometer, the second mobile body 20 measures a wind speed vector at the position of the second mobile body 20.

The control apparatus according to the present embodiment predicts, on the basis of the wind speed vector measured at the second mobile body 20, a wind power to be applied to the first mobile body 10 after elapse of a predetermined time period, and controls the first mobile body 10 on the basis of the predicted wind power. Accordingly, the control apparatus can cause the first mobile body 10 to generate a thrust force for canceling the wind power to be applied to the first mobile body 10. Thus, the position and the posture of the first mobile body 10 can be inhibited from being disturbed by such a disturbance as a strong wind.

The control apparatus according to the present embodiment. may be a control unit provided on the first mobile body 10. Alternatively, the control apparatus according to the present embodiment may be an information processing apparatus capable of wirelessly communicating with the first mobile body 10 and the second mobile body 20.

### <2. Configuration of Control Apparatus>

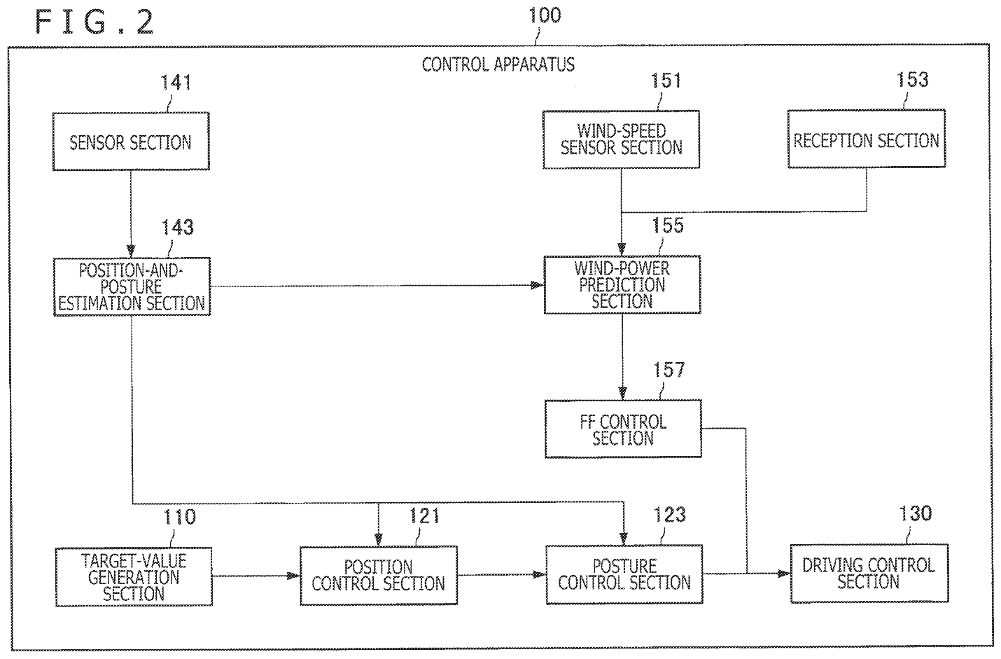

Next, the configuration of the control apparatus according to the present embodiment, the outline of which has been explained above, will specifically be explained with reference to FIGS. 2 to 4. Hereinafter, an explanation will be given on the assumption that the control apparatus according to the present embodiment is provided on the first mobile body 10, and is configured to control overall driving of the first mobile body 10. FIG. 2 is a block diagram for explaining the functional configuration of the control apparatus according to the present embodiment.

As depicted in FIG. 2, a control apparatus 100 according to the present embodiment includes a target-value generation section 110, a position control section 121, a posture control section 123, a driving control section 130, a sensor section 141, a position-and-posture estimation section 143, a wind-speed sensor section 151, a reception section 153, a wind-power prediction section 155, and an FF control section 157.

The target-value generation section 110 generates target values of the position. and the posture of the first mobile body 10. Specifically, the target-value generation section 110 generates the target values of the position and the posture of the first mobile body 10 on the basis of a movement command transmitted from a transmitter that is operating the first mobile body 10 by radio waves or a movement plan generated internally in the first mobile body 10. For example, the target-value generation section 110 may generate target values of x, and z coordinates (i.e., the position) of the first mobile body 10 at a predetermined time point a target value of the yaw angle (i.e., the posture) of the first mobile body 10 at the predetermined time point.

The position control section 121 generates a command value for controlling the position of the first mobile body 10, and further, generates a target value of a posture angle of the first mobile body 10. Specifically, the position control section 121 calculates errors between the target values of the position and the posture of the first mobile body 10 and estimated values of the position and the posture of the first mobile body 10, generates a command value for controlling the position and the posture to correct the calculated errors, and generates a target value of the posture angle. For example, the position control section 121 may generate a command value for a driving section (not depicted) for controlling the x, y, and z coordinates (i.e., the position) and the yaw angle (i.e., the posture) of the first mobile body 10 and target values of the roll angle and the pitch angle (i.e., the posture angles) of the first mobile body 10.

The posture control section 123 generates command values for controlling the posture angle and the posture angular speed of the first mobile body 10. Specifically, the posture control section 123 calculates an error between the target value of the posture angle of the first mobile body 10 and an estimated value of the posture angle of the first mobile body 10 and generates a command value for controlling the posture angle to correct the calculated error. In addition, in a manner similar to that for the posture angle, the posture control section 123 calculates an error between the target value of the posture angular speed of the first mobile body 10 and an estimated value of the posture angular speed of the first mobile body 10 and generates a command value for controlling the posture angular speed to correct the calculated error. For example, the posture control section 123 may generate a command value for a driving section (not depicted) for controlling the roll angle and the pitch angle (i.e., posture angles) of the first mobile body 10 and a command value for a driving section (not depicted) for Controlling the roll angular speed and the pitch angular speed (i.e., the posture angular speeds).

The sensor section 141 senses the state of the first mobile body 10. Specifically, the sensor section 141 senses information regarding the position and the posture of the first mobile body 10. For example, the sensor section 141 may include various cameras including an RGB camera, a gray scale camera, a stereo camera, a depth camera, an infrared camera, and a ToF (Time of Flight) camera and an IMU (Inertial Measurement Unit), an atmospheric sensor, a magnetic sensor, or a GNSS (Global Navigation Satellite System) sensor. It is to be noted that the sensor section 141 may include a plurality of such sensors.

The position-and-posture estimation section 143 estimates the position and the posture of the first mobile body 10 on the basis of the information regarding the position and the posture of the first mobile body 10 obtained through the sensing performed by the sensor section 141. Specifically, the position-and-posture estimation section 143 estimates the position, the posture, the speed, and the angular speed of the first mobile body 10 by integrating observation values obtained by plural sensors included in the sensor section 141. For example, the position-and-posture estimation section 143 may estimate the position, the posture, the speed, and the angular speed of the first mobile body 10 by using a Kalman filter.

The wind-speed sensor section 151 measures a wind speed vector at the first mobile body 10. Specifically, the wind-speed sensor section 151 may measure the strength and the direction of a wind at the first mobile body 10. For example, the wind-speed sensor section 151 may be an anemovane mounted on the first mobile body 10.

The reception section 153 receives at least one information set regarding a wind speed vector observed by an anemometer that is external to the first mobile body 10. Specifically, the reception section 153 receives, from an anemometer that is provided on the second mobile body 20 or an observation machine that is located around the first mobile body 10, at least one information set regarding a wind speed vector measured by the anemometer. For example, from the second mobile body 20, the reception section 153 may receive information regarding wind strength and a wind direction measured by an anemometer provided on the second mobile body 20, information regarding the position and the posture of the second mobile body 20, and information regarding a measurement time point of the wind speed vector. For example, through wireless communications based on a publicly known method, the reception section 153 may receive information regarding the wind speed vector from the anemometer provided on the second mobile body 20 or the observation machine. In addition, the reception section 153 may receive information regarding wind speed vectors respectively measured by plural anemometers located at different positions.

On the basis of the wind speed vector observed by the anemometer that is external to the first mobile body 10, the wind-power prediction section 155 predicts a wind power to be applied to the first mobile body 10 after elapse of a prescribed time period. Specifically, on the basis of the wind speed vector measured by the anemometer of the second mobile body 20, the wind-power prediction section 155 predicts the wind power to be applied to the first mobile body 10 after elapse of the prescribed time period.

For example, by performing a fluid simulation using wind speed vectors measured by plural anemometers that are external to the first mobile body 10, the wind-power prediction section 155 may predict a wind power to be applied to the first mobile body 10 after elapse of the prescribed time period. The fluid simulation can be performed by numerically solving simultaneous equations including an equation continuous to a Navier-Stokes equation, any other energy equation, a Maxwell's equation, etc.

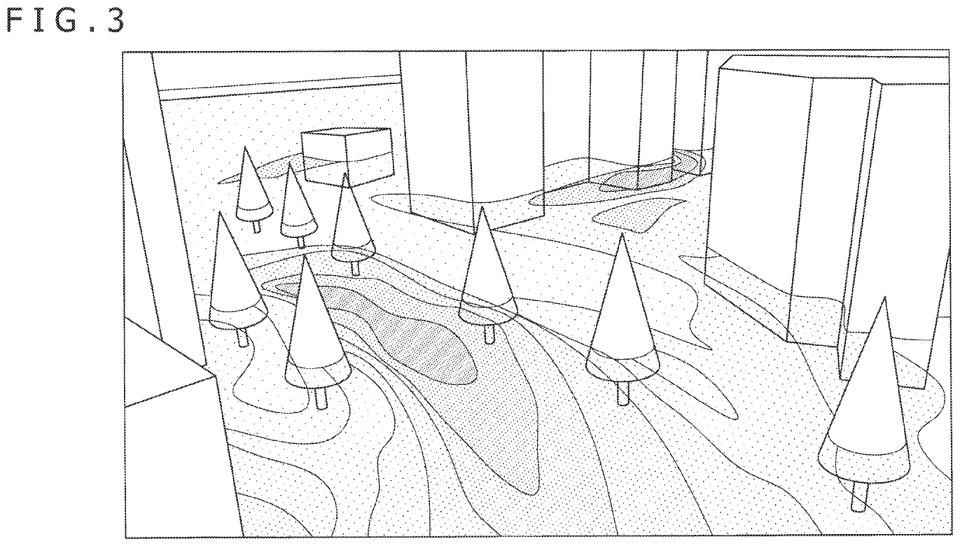

In such a case, the wind-power prediction section 155 may create a heat map in which the magnitudes and directions of wind speed vectors in the surrounding area of the first mobile body 10 are mapped, as depicted in FIG. 3, by further using information regarding an environmental structure around the first mobile body 10. FIG. 3 is a schematic diagram depicting one example of the heat map indicating wind speed vectors at respective positions in a predetermined environment. On the basis of this map, the wind-power prediction section 155 can precisely predict a wind speed vector at the position of the first mobile body 10 after elapse of the predetermined time period. Thus, the wind-power prediction section 155 can precisely predict the wind power to be applied to the first mobile body 10 after elapse of the prescribed time period.

Alternatively, the wind-power prediction section 155 may predict the wind power to be applied to the first mobile body 10 after elapse of the prescribed time period, on the presumption that wind that corresponds to a wind speed vector measured by an anemometer on the downwind side of which the first mobile body 10 is located propagates to the first mobile body 10. In such a case, even in a case where there are few calculation sources and observation results of wind speed vectors, the wind-power prediction section 155 can predict the wind power to be applied to the first mobile body 10 after elapse of the predetermined time period, in a simpler manner than the fluid simulation.

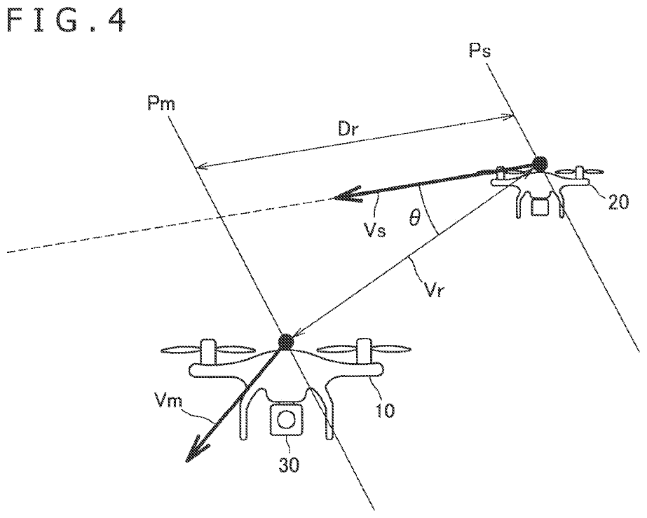

Hereinafter, such a simple method of predicting a wind power by means of the wind-power prediction section 155 will be explained with reference to FIG. 4. FIG. 4 is an explanatory diagram for explaining a method of predicting a wind speed vector at the first mobile body 10 from a wind speed vector at the second mobile body 20.

As depicted in FIG. 4, the wind-power prediction section 155 may predict the wind speed vector at the first mobile body 10 after elapse of the predetermined time period, on the presumption that a wind speed vector at the second mobile body 20 on the downwind side of which the first mobile body 10 is located propagates to the first mobile body 10 after elapse of the predetermined time period.

Specifically, the wind-power prediction section 155 calculates an angle θ formed between a vector Vr that connects the first mobile body 10 to the second mobile body 20 and a wind speed vector Vs observed at the second mobile body 20. Next, the wind-power prediction section 155 may predict a wind speed vector at the first mobile body 10 after elapse of the predetermined time period, by using a wind speed vector at the second mobile body 20 at which the smallest angle θ is obtained and which is among the second mobile bodies 20 that are located at distances within a predetermined range with respect to the first mobile body 10. Alternatively, the wind-power prediction section 155 may predict the wind speed vector at the first mobile body 10 after elapse of the predetermined time period, by using a wind speed vector at the second mobile body 20 at which the smallest angle θ is obtained.

In still another case, the wind-power prediction section 155 may predict the wind speed vector at the first mobile body 10 after elapse of the predetermined time period, by using a wind speed vector at the second mobile body 20 that is located at the shortest distance from the first mobile body 10. In yet another case, the wind-power prediction section 155 may predict the wind speed vector at the first mobile body 10 after elapse of the predetermined time period, by using a wind speed vector at the second mobile body 20 that is located at the shortest distance from the first mobile body 10 and that is among the second mobile bodies 20 at which the angles θ that fall within a predetermined range are obtained.

For example, it is assumed that a distance Dr between a plane Pm that is perpendicular to a wind speed vector Vm at the first mobile body 10 and that includes the first mobile body 10 within the plane and a plane Ps that is perpendicular to a wind speed vector Vs at the second mobile body 20 and that includes the second mobile body 20 within the plane is 5 m. Further, it is assumed that the wind speed of the wind speed vector Vs at the second mobile body 20 is 10 m/s.

In this case, a time T that is taken for the wind speed vector Vs at the second mobile body 20 to propagate to the first mobile body 10 can be presumed to be T=5 (m)/10 (m/s)=0.5 (s). Thus, the wind speed vector VM at the first mobile body 10 after elapse of a predetermined time period t can be predicted by summing the wind speed vector Vm and the wind speed vector Vs at the second mobile body 20 in accordance with Expression 1:

VM=Vm×(1−t/T)+Vs×t/T (where, t≤T) expression 1

Consequently, in a case where t=0.1 holds, for example, the wind-power prediction section 155 can predict that the wind speed vector VM at the first mobile body 10 after elapse of 0.1 seconds is VM=0.8 Vm+0.2 Vs.

Accordingly, the wind-power prediction section 155 can predict the wind speed vector at the first mobile body 10 after elapse of the predetermined time period by a simpler method, without performing a complicated fluid simulation, and can predict the wind power to be applied to the first mobile body 10 after elapse of the predetermined time period.

The FF control section 157 generates a command value for causing a driving section (not depicted) of the first mobile body 10 to generate a thrust force for canceling the wind power to be applied to the first mobile body 10 after elapse of the predetermined time period. Specifically, the FF control section 157 generates a command value for causing the driving section to generate a thrust force for canceling the wind power to be applied to the first mobile body 10 predicted by the wind-power prediction section 155 and maintaining the position and the posture of the first mobile body 10. That is, the FF control section 157 performs feedforward control on the driving section to cancel, in advance, the wind power predicted to be applied to the first mobile body 10.

The driving control section 130 controls a driving section (not depicted) that drives the first mobile body 10. Specifically, the driving control section 130 controls the position and the posture of the first mobile body 10 by controlling the driving section on the basis of the command values sent from the FF control section 157, the position control section 121, and the posture control section 123. For example, the driving control section 130 may control the position and the posture of the first mobile body 10, by controlling a motor, an actuator, or the like on the basis of a command value obtained by adding the command value for canceling the wind power to be applied after elapse of the predetermined time period to command values for controlling the x, y, and z coordinates, the yaw angle, the roll angle, the pitch angle, the roll angular speed, and the pitch angular speed.

With the control apparatus 100 having the abovementioned configuration, a wind power to be applied to the first mobile body 10 can be predicted in advance. Therefore, feedforward control of driving of the first mobile body 10 can be performed in such a manner as to inhibit the wind power from changing the position and the posture.

### <3. Operation of Control Apparatus>

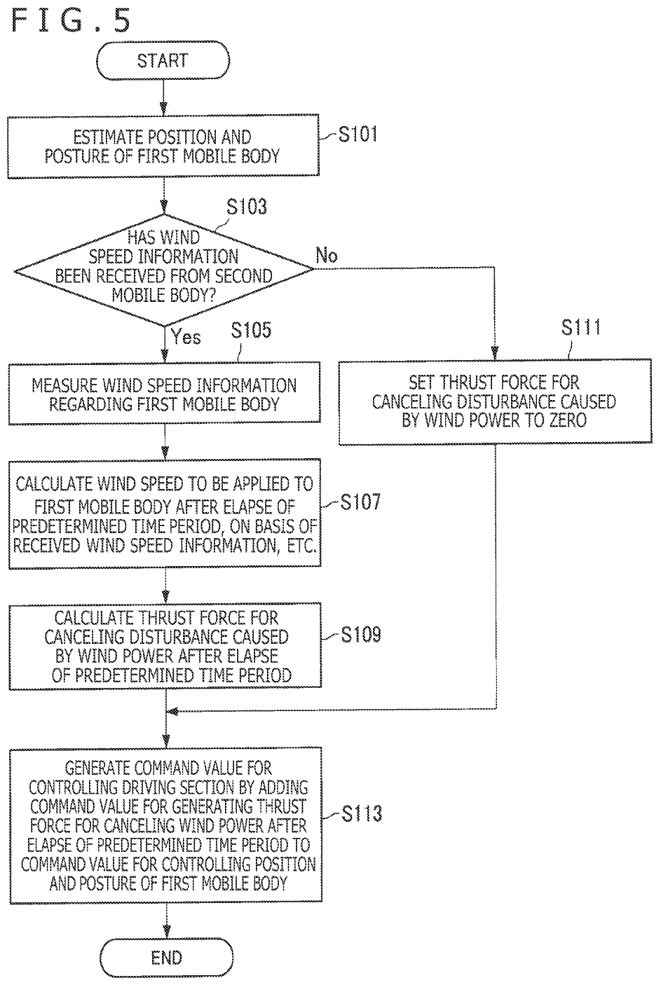

Next, operation of the control apparatus 100 according to the present embodiment will be explained with reference to FIG. 5. FIG. 5 is a flowchart for explaining the operation flow of the control apparatus 100 according to the present embodiment.

As depicted in FIG. 5, the control apparatus 100 first estimates the position and the posture of the first mobile body 10 on the basis of information obtained through sensing performed by the sensor section 141 (S101). Next, the control apparatus 100 determines whether or not wind speed information including a wind speed vector at the second mobile body 20 has been received from the second mobile body 20 via the reception section 153 (S103). In a case where the wind speed information has been received from the second mobile body 20 (Yes in S103), the control apparatus 100 measures, by means of the wind-speed sensor section 151, wind speed information including a wind speed vector at the first mobile body 10 (S105).

Next, the control apparatus 100 calculates, by means of the wind-power prediction section 155, a wind power to be applied to the first mobile body 10 after elapse of a predetermined time period, on the basis of the wind speed vector at the first mobile body 10, the wind speed vector at the second mobile body 20, information regarding the position and the posture of the first mobile body 10, and information regarding the position and the posture of the second mobile body 20 (S107). Next, the control apparatus 100 calculates, by means of the FF control section 157, a thrust force for canceling a disturbance which is caused by the wind power against the first mobile body 10 after elapse of the predetermined time period (S109). On the other hand, in a case where the wind speed information has not been received from the second mobile body 20 (No in S103), the control apparatus 100 sets, by means of the FF control section 157, a thrust force for canceling a disturbance which is caused by the wind power against the first mobile body 10 after elapse of the predetermined time period, to zero (S111).

Thereafter, the control apparatus 100 controls, by means of the driving control section 130, a driving section of the first mobile body 10 on the basis of a command value obtained by adding a command value for generating the thrust force for canceling the wind power to be applied after elapse of the predetermined time period, to a command value for controlling the position and the posture of the first mobile body 10 (S113).

According to the abovementioned operation flow, the control apparatus 100 can predict the wind power to be applied to the first mobile body 10 after elapse of the predetermined time period, on the basis of the wind speed vector measured at the second mobile body 20. Consequently, the control apparatus 100 can control driving of the first mobile body 10 in such a manner as to keep the position and the posture thereof against the wind power to be applied.

### <4. Variations>

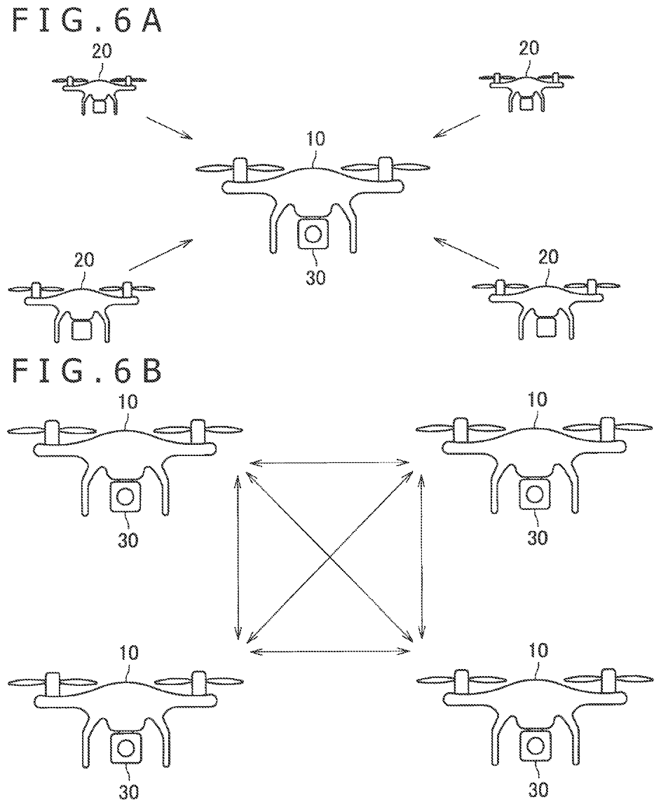

Next, variations of control which is performed by the control apparatus 100 according to the present embodiment will be explained with reference to FIGS. 6A to 8.

First, variations of the relation between the first mobile body 10 driving of which is under control of the control apparatus 100 according to the present embodiment and the second mobile body 20 including an anemometer that observes a wind speed vector to be used for control performed by the control apparatus 100 will be explained with reference to FIGS. 6A and 6B. FIG. 6A is an explanatory diagram depicting an example in which plural second mobile bodies 20 each including an anemometer are used to cause the first mobile body 10 including the imaging apparatus 30 to make a stable flight. FIG. 6B is an explanatory diagram depicting an example in which plural first mobile bodies 10 each including an anemometer and the imaging apparatus 30 are caused to make mutually stable flights.

As depicted in FIG. 6A, the control apparatus 100 may arrange plural second mobile bodies 20 each including the anemometer, around the first mobile body 10 including the imaging apparatus 30, and may measure wind speed vectors at the plural second mobile bodies 20 to stabilize the position and the posture of the first mobile body 10.

It is important for the first mobile body 10 to stably maintain the position and the posture thereof against a sudden strong wind or the like because the first mobile body 10 performs a work of capturing an image from a position in the air. Thus, the control apparatus 100 arranges the plural second mobile bodies 20 each including an anemometer in such a manner that the plural second mobile bodies 20 surround the first mobile body 10 so that the first mobile body 10 can always be present on the downwind side of any one of the second mobile bodies 20 even in a case where the wind direction changes with time. Accordingly, the control apparatus 100 can measure the wind speed vector of a wind blowing in any wind direction by using the second mobile body 20 that is located on the upwind side of the first mobile body 10. Therefore, with high precision, the control apparatus 100 can predict a wind power to applied to the first mobile body 10 after elapse of a predetermined time period.

As depicted in FIG. 6B, the control apparatus 100 may measure wind speed vectors at plural first mobile bodies 10 each including the imaging apparatus 30 and an anemometer, and may share the measured wind speed vectors among the first mobile bodies 10 to stabilize the positions and the postures of the first mobile bodies 10.

Each of the first mobile bodies 10 may include an anemometer in order to control the position and the posture. Thus, the measured wind speed vectors are shared by the plural first mobile bodies 10, so that the control apparatus 100 can stably control the positions and the postures of the first mobile bodies 10, without using any second mobile body 20 that measures a wind speed vector. Accordingly, the control apparatus 100 can improve the energy consumption efficiencies at the first mobile bodies 10 and the second mobile body 20.

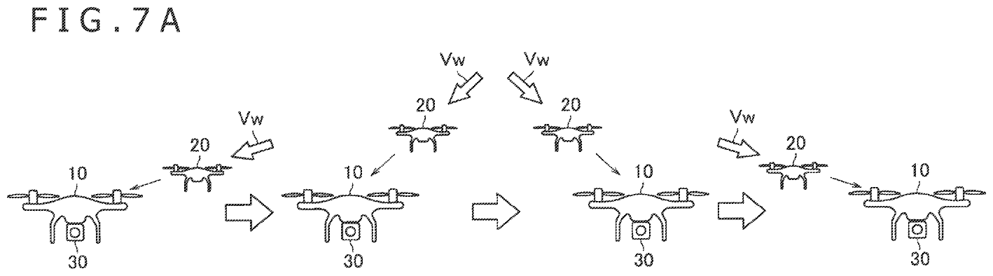

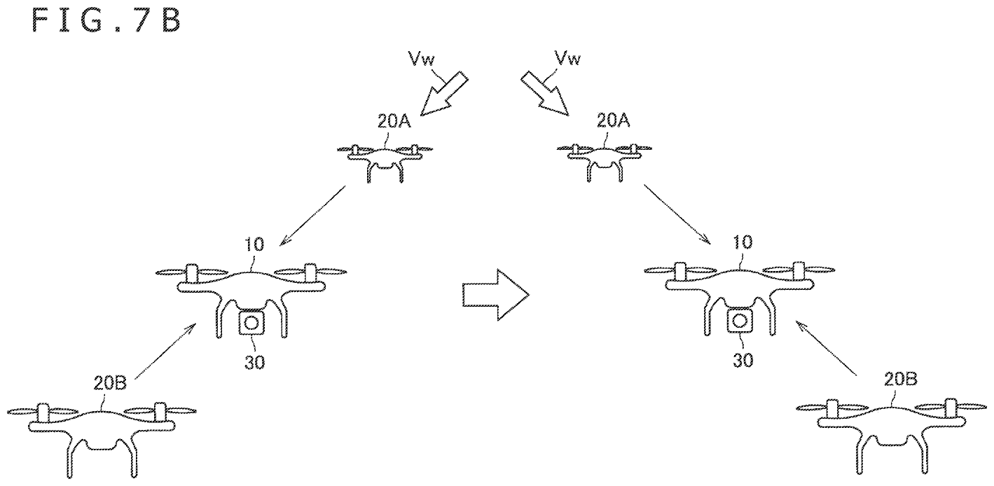

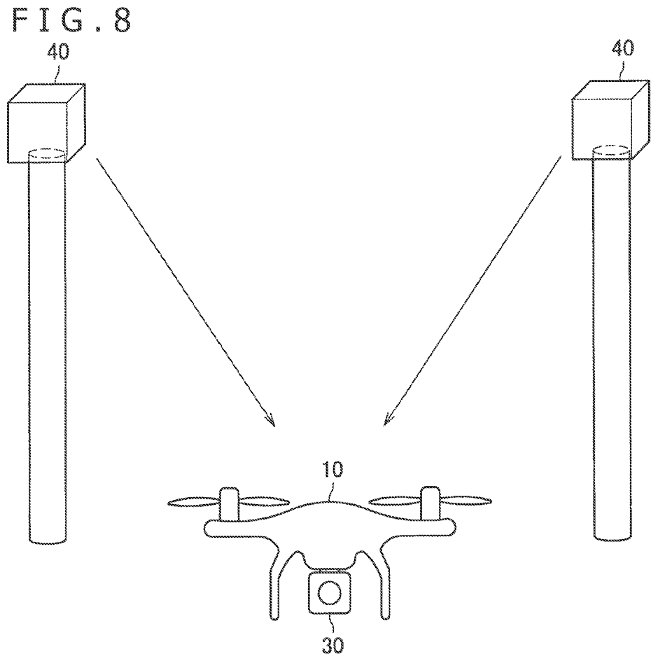

Next, variations of arrangement control of the first mobile body 10 and the second mobile body 20 by the control apparatus 100 according to the present embodiment will be explained with reference to FIGS. 7A and 7B. FIG. 7A is an explanatory diagram depicting an arrangement example of the first mobile body 10 and the second mobile body 20. FIG. 7B is an explanatory diagram depicting an arrangement, example of the first mobile body 10 and plural second mobile bodies 20.

As depicted in FIG. 7A, the control apparatus 100 may perform arrangement control of the second mobile body 20 such that the first mobile body 10 is always present on the downwind side of the second mobile body 20. Specifically, the control apparatus 100 may perform arrangement control of the second mobile body 20 such that the first mobile body 10 is always present in the direction of a wind speed vector Vw measured at the second mobile body 20. Accordingly, with higher precision, the control apparatus 100 can predict, on the basis of the wind speed vector Vw measured at the second mobile body 20, a wind power to be applied to the first mobile body 10 after elapse of a predetermined time period.

As depicted in FIG. 7B, the control apparatus 100 may perform arrangement control of plural second mobile bodies 20 such that the second mobile bodies 20 are located at positions opposite to each other with the first mobile body 10 interposed therebetween. Specific the control apparatus 100 may perform arrangement control the second mobile bodies 20 such that the second mobile bodies 20 are always present on each of the upwind and downwind sides of the first mobile body 10.

For example, the control apparatus 100 may perform arrangement control of the second mobile bodies 20A and 20B such that, with respect to the direction of the wind speed vector Vw measured at the first mobile body 10, the second mobile body 20A is always present on the upwind side of the first mobile body 10 while the second mobile body 20B is always present on the downwind side of the first mobile body 10. Accordingly, even in a case where the wind direction suddenly changes, the control apparatus 100 can have either one of the second mobile bodies 20 always present on the upwind side of the first mobile body 10. Therefore, the control apparatus 100 can more smoothly perform arrangement control of the second mobile bodies 20 with respect to the first mobile body 10.

It is to be noted that, by further using information regarding the position, the image capturing direction, the angle of view, etc., of the first mobile body 10, the control apparatus 100 may perform arrangement control of the second mobile body 20 so as to inhibit the second mobile body 20 from entering the angle of view of the imaging apparatus 30 of the first mobile body 10. Further, the position of the second mobile body 20 may be controlled, not by the control apparatus 100, but by the second mobile body 20 itself.

Next, a variation of an anemometer that obtains a wind speed vector that is used by the control apparatus 100 according to the present embodiment to predict a wind power to be applied to the first mobile body 10 will be explained with reference to FIG. 8. FIG. 8 is an explanatory diagram for explaining an observation machine including an anemometer that measures a wind speed vector.

As depicted in FIG. 8, the control apparatus 100 may predict a wind power to be applied to the first mobile body 10 after elapse of a predetermined time period, on the basis of a wind speed vector measured by the anemometer provided on the observation machine 40 the position of which is fixed. That is, a wind speed vector that is used by the control apparatus 100 to predict a wind power to be applied to the first mobile body 10 may be measured by an anemometer provided on such a mobile apparatus as the second mobile body 20, or may be measured by an anemometer provided on such a position-fixed apparatus as the observation machine 40. When predicting a wind power to be applied to the first mobile body 10, the control apparatus 100 can use any wind speed vector as long as the measurement position and the measurement timing of the wind speed vector are identified.

### <5. Hardware Configuration>

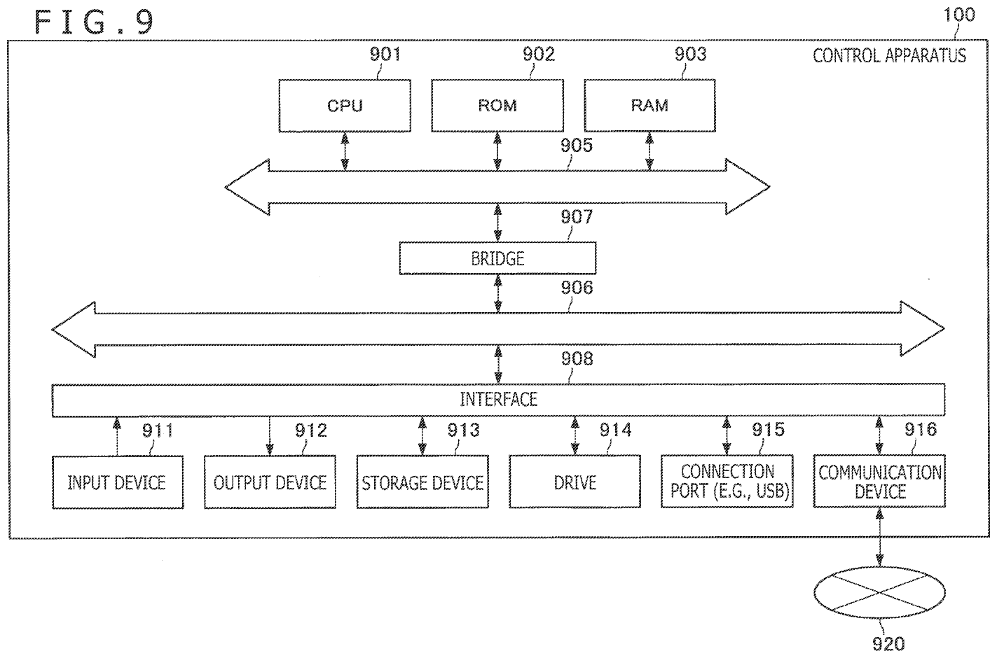

Next, a hardware configuration of the control apparatus 100 according to the present embodiment will be explained with reference to FIG. 9. FIG. 9 is a block diagram depicting one example of the hardware configuration of the control apparatus 100 according to the present embodiment.

As depicted in FIG. 9, the control apparatus 100 includes a CPU (Central Processing Unit) 901, a ROM (Read Only Memory) 902, a RAM (Random Access Memory) 903, a host bus 905, a bridge 907, an external bus 906, an interface 908, an input device 911, an output device 912, a storage device 913, a drive 914, a connection port 915, and a communication device 916. The control apparatus 100 may include a processing circuit such as an electric circuit, a DSP (Digital Signal Processor), or an ASIC (Application Specific Integrated Circuit), in place of the CPU 901 or in addition to the CPU 901.

The CPU 901 functions as an arithmetic processing device and a control device to control all the operations of the control apparatus 100 in accordance with various programs. In addition, the CPU 901 may be a microprocessor. The ROM 902 stores a program, a computing parameter, etc., that are used by the CPU 901. The RAM 903 temporarily stores a program that is to be used during execution in the CPU 901 and a parameter that varies during the execution, as appropriate, for example. The CPU 901 may execute the functions of the target-value generation section 110, the position control section 121, the posture control section 123, the driving control section 130, the position-and-posture estimation section 143, the wind-power prediction section 155, and the FF control section 157, for example.

The CPU 901, the ROM 902, and the RAM 903 are mutually connected via the host bus 905 including a CPU bus or the like. The host bus 905 is connected, via the bridge 907, to the external bus 906 which is a PCI (Peripheral Component Interconnect/Interface) bus or the like. It is to be noted that the host bus 905, the bridge 907, and the external bus 906 are not necessarily required to be formed separately, and the functions of the host bus 905, the bridge 907, and the external bus 906 may be mounted on one bus.

The input device 911 is, for example, a mouse, a keyboard, a touch panel, a button, a microphone, a switch, or a lever by which information is inputted by a user. Further, the input device 911 may include an input control circuit or the like for generating an input signal on the basis of information inputted by a user using the abovementioned input means, for example. In addition, the input device 911 may include a sensor and a circuit for observing the environment or the state of a mobile body and generating a detection signal based on the observation result. The input device 911 may execute the functions of the sensor section 141 and the wind-speed sensor section 151, for example.

The output device 912 is capable of visually or audibly notifying a user of information. For example, the output device 912 may be a display device such as a CRT (Cathode Ray Tube) display device, a liquid crystal display device, a plasma display device, an EL (ElectroLuminescence) display device, a laser projector, an LED (Light Emitting Diode) projector, or a lamp, a sound output device such as a loudspeaker or a headphone, or the like.

The output device 912 may output a result obtained through various processes performed in the control apparatus 100, for example. Specifically, the output device 912 may display a result obtained through various processes performed in the control apparatus 100, in a visual manner using various forms such as text, images, tables, and graphs. Alternatively, the output device 912 may convert an audio signal of sound data or acoustic data into an analog signal, and output the analog signal in an audible manner.

The storage device 913 is a data storing device that is formed as one example of a storage section of the control apparatus 100. For example, the storage device 913 may be implemented by a magnetic storage device such as an HDD (Hard Disk Drive), a semiconductor storage device, an optical storage device, or a magneto-optical storage device. For example, the storage device 913 may include a storage medium, a recording unit that records data into the storage medium, a reading unit that reads out data from the storage medium, a deleting unit that deletes data recorded in the storage medium, and the like. The storage device 913 may store a program to be executed by the CPU 901, various kinds of data, various kinds of data acquired from the outside, and the like.

The drive 914 is a reader/writer for storage media, and is disposed internally in or externally to the control apparatus 100. The drive 914 reads out information recorded in a removable storage medium such as a magnetic disk, an optical disk, a magneto-optical disk, or a semiconductor memory while the removable storage medium is attached to the drive 914, and the drive 914 outputs the read information to the PAM 903. Further, the drive 914 is capable of writing information into a removable storage medium.

The connection port 915 is an interface that is connected to an external apparatus. The connection port 915 is a connection port through which data can be exchanged with an external apparatus. For example, the connection port 915 may be a USB (Universal Serial Bus).

The communication device 916 is an interface that includes a communication device for establishing connection with the network 920, for example. The communication device 916 may be a wired or wireless LAN (Local Area Network), or a communication card for LTE (Long Term Evolution), Bluetooth (registered trademark), or WUSB (Wireless USE), for example. In addition, the communication device 916 may be a router for optical communication, a router for ADSL (Asymmetric Digital Subscriber Line), or a modem for various types of communication. The communication device 916 is capable of exchanging a signal, etc., with the internet or another communication apparatus in accordance with a predetermined protocol such as TCP/IP, for example. The communication device 916 may execute the function of the reception section 153, for example.

It is to be noted that the network 920 is a wired or wireless information transmission path. For example, the network 920 may include the internet, a public line network such as a telephone line or a satellite communication network, various types of LAN (Local Area Network) including Ethernet (registered trademark), a WAN (Wide Area Network), or the like. In addition, the network 920 may include a dedicated line network such as an IP-VPN (Internet Protocol-Virtual Private Network).

It is to be noted that even a computer program for causing the hardware including the CPU, the ROM, and the RAM internally disposed in the control apparatus 100, to exert functions equivalent to those of the abovementioned sections of the control apparatus 100 according to the present embodiment can be created. In addition, a storage medium having such a computer program stored therein can be provided.

The preferred embodiment of the present disclosure has been explained above in detail with reference to the attached drawings, but the technical scope of the present disclosure is not limited to such an embodiment. It is clear that a person having ordinary knowledge in the technical field of the present disclosure can conceive of various changes and modifications within the scope of the technical idea set forth in the claims. It is understood that such changes and modifications also naturally fall within the technical scope of the present disclosure.

In addition, it is to be noted that the effects described in the present description are just explanatory or exemplary effects, and thus, are not limitative. That is, the technology according to the present disclosure can provide any other effect that is clear to a person skilled in the art from the explanation in the present description, in addition to or in place of the abovementioned effects.

It is to be noted that the technical scope of the present disclosure also encompasses the following configurations.

(1)

A control apparatus including:

a reception section that receives a wind speed vector measured at any time point by at least one external anemometer;

a wind-power prediction section that, on the basis of the received wind speed vector, predicts a wind power to be applied to a mobile body after elapse of a predetermined time period; and

a control section that controls driving of the mobile body on the basis of the predicted wind power.

(2)

The control apparatus according to (1), in which

the control section controls driving of the mobile body in such a manner as to cancel the wind power.

(3)

The control apparatus according to (1) or (2), in which,

further on the basis of a wind speed vector measured by an internal anemometer installed in the mobile body, the wind-power prediction section predicts the wind power to be applied to the mobile body after elapse of the predetermined time period.

(4)

The control apparatus according to any one of (1) to (3), in which,

further on the basis of environmental information regarding a surrounding area of the mobile body, the wind-power prediction section predicts the wind power to be applied to the mobile body after elapse of the predetermined time period.

(5)

The control apparatus according to any one of (1) to (4), in which,

on the basis of the wind speed vectors measured by the external anemometers provided in plural numbers and placed at different positions, the wind-power prediction section predicts the wind power to be applied to the mobile body after elapse of the predetermined time period.

(6)

The control apparatus according to (5), in which,

on the basis of the wind speed vector measured by the external anemometer on a downwind side of which the mobile body is located, the wind-power prediction section predicts the wind power to be applied to the mobile body after elapse of the predetermined time period.

(7)

The control apparatus according to (5) or (6), in which,

on the basis of the wind speed vector measured by the external anemometer that is present within a predetermined distance from the mobile body, the wind-power prediction section predicts the wind power to be applied to the mobile body after elapse of the predetermined time period.

(8)

The control apparatus according any one of (1) to (7), in which

the external anemometer is provided in another mobile body that is different from the mobile body.

(9)

The control apparatus according to (8), in which

the other mobile body is controlled such that the mobile body is present in a downwind direction of the other mobile body.

(10)

The control apparatus according to (8), in which

the other mobile body including the external anemometer is provided in plural numbers, and

the other mobile bodies are controlled to be located at positions opposite to each other with the mobile body interposed therebetween.

(11)

The control apparatus according to (10), in which

the other mobile bodies are controlled to be located in each of an upwind direction of the mobile body and in a downwind direction of the mobile body.

(12)

The control apparatus according to any one of (1) to (11), in which

the mobile body includes a flying body that flies with a rotary blade.

(13)

The control apparatus according to any one of (1) to (12), in which

the mobile body includes an imaging apparatus.

(14)

A control method including:

receiving a wind speed vector measured at any time point by at least one external anemometer;

predicting, by an arithmetic device, on the basis of the received wind speed vector, a wind power to be applied to a mobile body after elapse of a predetermined time period; and

controlling driving of the mobile body on the basis of the predicted wind power.

(15)

A program for causing a computer to function as:

a reception section that receives a wind speed vector measured at any time point by at least one external anemometer;

a wind-power prediction section that, on the basis of the received wind speed vector, predicts a wind power to be applied to a mobile body after elapse of a predetermined time period; and

a control section that controls driving of the mobile body on the basis of the predicted wind power.

### REFERENCE SIGNS LIST

10: First mobile body

20: Second mobile body

30: Imaging apparatus

40: Observation machine

100: Control apparatus

110: Target-value generation section

121: Position control section

123: Posture control section

130: Driving control section

141: Sensor section

143: Position-and-posture estimation section

151: Wind-speed sensor section

153: Reception section

155: Wind-power prediction section

157: FF control section

1. A control apparatus comprising:
a reception section that receives a wind speed vector measured at any time point by at least one external anemometer;
a wind-power prediction section that, on a basis of the received wind speed vector, predicts a wind power to be applied to a mobile body after elapse of a predetermined time period; and
a control section that controls driving of the mobile body on a basis of the predicted wind power.

2. The control apparatus according to claim 1, wherein
the control section controls driving of the mobile body in such a manner as to cancel the wind power.

3. The control apparatus according to claim 1, wherein,
further on a basis of a wind speed vector measured by an internal anemometer provided on the mobile body, the wind-power prediction section predicts the wind power to be applied to the mobile body after elapse of the predetermined time period.

4. The control apparatus according to claim 1, wherein,
further on a basis of environmental information regarding a surrounding area of the mobile body, the wind-power prediction section predicts the wind power to be applied to the mobile body after elapse of the predetermined time period.

5. The control apparatus according to claim 1, wherein,
on a basis of the wind speed vectors measured by the external anemometers provided in plural numbers and placed at different positions, the wind-power prediction section predicts the wind power to be applied to the mobile body after elapse of the predetermined time period.

6. The control apparatus according to claim 5, wherein,
on a basis of the wind speed vector measured by the external anemometer on a downwind side of which the mobile body is located, the wind-power prediction section predicts the wind power to be applied to the mobile body after elapse of the predetermined time period.

7. The control apparatus according to claim 5, wherein,
on a basis of the wind speed vector measured by the external anemometer that is present within a predetermined distance from the mobile body, the wind-power prediction section predicts the wind power to be applied to the mobile body after elapse of the predetermined time period.

8. The control apparatus according to claim 1, wherein
the external anemometer is provided in another mobile body that is different from the mobile body.

9. The control apparatus according to claim 8, wherein
the other mobile body is controlled such that the mobile body is present in a downwind direction of the other mobile body.

10. The control apparatus according to claim 8, wherein
the other mobile body including the external anemometer is provided in plural numbers, and
the other mobile bodies are controlled to be located at positions opposite to each other with the mobile body interposed therebetween.

11. The control apparatus according to claim 10, wherein
the other mobile bodies are controlled to be located in each of an upwind direction of the mobile body and in a downwind direction of the mobile body.

12. The control apparatus according to claim 1, wherein
the mobile body includes a flying body that flies with. a rotary blade.

13. The control apparatus according to claim 1, wherein
the mobile body includes an imaging apparatus.

14. A control method comprising:
receiving a wind speed vector measured at any time point by at least one external anemometer;
predicting, by an arithmetic device, on a basis of the received wind speed vector, a wind power to be applied to a mobile body after elapse of a predetermined time period; and
controlling driving of the mobile body on a basis of the predicted wind power.

15. A program for causing a computer to function as:
a reception section that receives a wind speed vector measured at any time point by at least one external anemometer;
a wind-power prediction section that, on a basis of the received wind speed vector, predicts a wind power to be applied to a mobile body after elapse of a predetermined time period; and
a control section that controls driving of the mobile body on a basis of the predicted wind power.
